(19) United States
(12) Patent Application Publication
(10) Pub. No.: US 2005/0178500 A1
(43) Pub. Date: Aug. 18, 2005

(54) Protective laminate and method for making same

(75) Inventors: Jacques Chevrette, St. Lijuori (CA); Chris Haas, North Bay (CA); Kent Metzger, Sioux Falls, SD (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 11/013,038

(22) Filed: Dec. 15, 2004

Related U.S. Application Data
(60) Provisional application No. 60/529,719, filed on Dec. 15, 2003.

(51) Int. Cl. B32B 31/00

(52) U.S. Cl. 156/291; 156/244.11

(57) ABSTRACT

The present invention is directed to a protective laminate, and more specifically to a durable woven and film protective laminate comprising an adhesive applied with a sputter coat technique and a vapor corrosive inhibitor that helps prevent the oxidation of metal goods and associated alloys during transport and storage.

### TECHNICAL FIELD

The present invention generally relates to a protective laminate, and more specifically to a durable woven and film protective laminate comprising an adhesive applied with a sputter coating technique and a vapor corrosive inhibitor that prevents the oxidation of metal goods and associated alloys during transport and storage.

### BACKGROUND OF THE INVENTION

The use of protective laminates for wrapping metal goods is generally known. Metal goods are traditionally wrapped before being transported and stored so as to protect the metal from the deleterious affects of the environment. Often the wrap is comprised of a vapor corrosive inhibitor in added effort to prevent oxidation of the metal.

The prior art consists of “shrink wraps” that contract about an object in the presence of heat; however shrink wraps can be problematic due to the heat source compromising the structural integrity of the film. Further, metal goods with sharp corners have the potential to tear shrink wraps due to the fitted nature of the wrap.

In addition to shrink wraps, woven and film laminates exist for the use of wrapping metals and associated alloys. The use of woven fabrics along with a film lends to the durability of the laminate. U.S. Pat. No. 6,242,371, to Quinones, herein incorporated by reference, discloses a tear and puncture resistant laminate impregnated with a volatile corrosion inhibitor for wrapping metal goods, wherein the laminate is adhered by narrow strips at the edges. Consequently, the narrow strips of adhesive have a negative affect on the handling of the fabric, whereby extra care is needed when wrapping an object to keep both layers together and prevent wrinkling of the laminate. Further, the strips of adhesive are prone to fracture during the wrapping process, initiating the delamination of the two layers. Further still, placement of the adhesive also affects the laminate. If the adhesive strips are recessed in from the edges, the laminate is trimmed with an unbonded portion of film and fabric. The unbonded portion could be easily caught during the wrapping process, resulting in the delamination of the product or cause wrinkles as aforementioned.

There remains an unmet need for a tear and puncture resistant metal wrap that is less rigid and more easily conforms about the edges of an object to be wrapped. In addition, there remains a need for a tear and puncture resistant metal wrap that is bonded along the outer most edges to deter delamination during the wrapping process and improve the handling ease, as well as wrapping time.

### SUMMARY OF THE INVENTION

The present invention is directed to a protective laminate, and more specifically to a durable woven and film protective laminate comprising an adhesive applied with a sputter coat technique and a vapor corrosive inhibitor that helps prevent the oxidation of metal goods and associated alloys during transport and storage.

In accordance with the present invention, the laminate is comprised of a woven fabric and a film with a vapor corrosive inhibitor (VCI) incorporated therein. The woven fabric is preferably a polyolefin. Suitable polyolefins include polyethylene or polypropylene, their derivatives, and combinations thereof. The synthetic polymers may be further selected from homopolymers; copolymers, conjugates and other derivatives including those thermoplastic polymers having incorporated melt additives or surface-active agents.

The woven fabric of the present invention may act as a scrim receiving an optional polyolefin coating that is extruded onto the first side of the fabric. An adhesive is then applied to the second side of the woven with a sputter coat technique. Subsequently, a film layer is introduced to the woven forming a durable laminate resistant to tears and punctures. Sputter coating droplets of adhesive randomly along the edges of the laminate creates continuous channels of unbonded regions that improve the handling and wrapping time required of laminate. Optionally, the adhesive may be sputter coated across the entire width of the fabric. As a result, objects are more easily wrapped and the laminate conforms better to the surface of the object.

The film of the present invention is preferably a low density polyethylene or linear low density polyethylene that comprises a VCI melt additive. It is in the purview of the present invention that the film may be comprised of any polyolefin, their derivatives, and the combinations thereof. In addition to a VCI melt additive, the film may optionally comprise one or more additional melt additives that alter the performance or aesthetic appeal of the film.

In one embodiment, the laminate of the present invention may comprise a woven and nonwoven that are adhered by a sputter coating technique. The nonwoven fabric may be a continuous or discontinuous filament fabric, carded staple fiber fabric, or a combination thereof. Further, the VCI may be incorporated into the melt of a filamentary fabric or applied topically to a carded fabric. The sputter coated adhesive that is applied extends near the outer most edges of the laminate in order to deter delamination of the woven and nonwoven fabric.

It has also been contemplated that the laminate comprises two or more layers. Additional layers may be wovens, nonwovens, films, or a combination thereof. Subsequent to formation, the laminate may also be exposed to various post treatments. Other features and advantages of the present invention will become readily apparent from the following detailed description, the accompanying drawings, and the appended claims.

### BRIEF DESCRIPTION OF THE DRAWINGS

FIG. 1 is a diagrammatic view of a protective laminate made in accordance with the present invention; and

FIG. 2 is a diagrammatic view of a protective laminate made in accordance with the present invention.

### DETAILED DESCRIPTION

While the present invention is susceptible of embodiment in various forms, hereinafter is described a presently preferred embodiment of the invention, with the understanding that the present disclosure is to be considered as an exemplification of the invention, and is not intended to limit the invention to the specific embodiment illustrated.

The durable protective laminate of the present invention is tear and puncture resistant in addition to being more easily wrapped about a metal object due to improved handlability. The woven fabric may act as a scrim, optionally receiving a polyolefin coating that is extruded onto the first side of the fabric. The polyolefin coating may be selected from the group consisting of polypropylene, polyethylene, their derivatives, and the combination thereof. A sputter coating of adhesive is applied to the second side of the woven. Air is introduced at the nozzle for which the adhesive is dispensed so as to randomly distribute the adhesive, leaving continuous channels of unbonded regions. The adhesive free regions allow the laminate to bend and conform to sharp edges without having a deleterious affect on the laminate.

In accordance with the present invention, a woven fabric comprised of yarns, fibers, and/or tapes are designated for specific use as warp or fill yarns. The fill yarns, tapes, or fiber packages (which run in the cross direction and are known as picks) are taken straight to the loom for weaving. The warp yarns (which run on in the machine direction and are known as ends) must be further processed. The packages of warp yarns are used to build a warp beam. Here the packages are placed onto a warper or beamer, which feeds multiple yarn ends onto the beam in a parallel array. The beam is then mounted onto the back of the loom. Here the warp and fill yarns, tapes, and/or fibers are interwoven to produce yardage of fabric. Subsequent to formation, the woven fabric is coated with a polyolefin on a first side and collected as a rolled good.

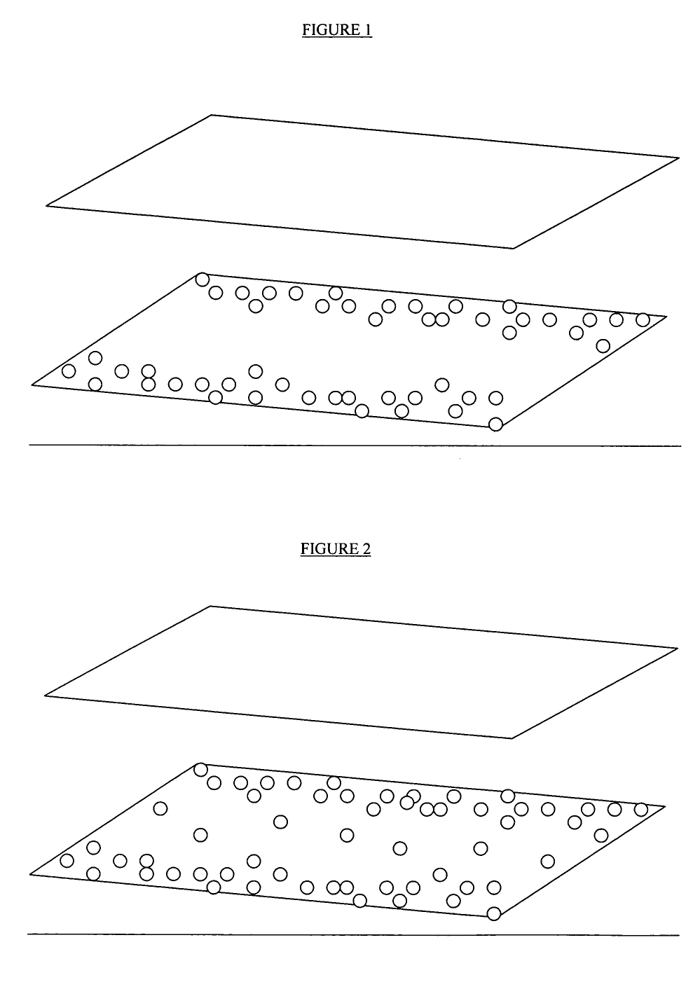

A second side of the woven fabric is sputter coated with an adhesive along both edges in 3 to 4 inch sections. FIG. 1 is illustrative of the random distribution of the adhesive droplets along the edges. Optionally, the adhesive may be sputter coated across the entire width of the fabric, as illustrated in FIG. 2. Subsequent to sputter coating the woven, a previously formed film layer is introduced to the woven layer and bonded thereto at their respective edges.

The formation of finite thickness films from thermoplastic polymers is a well-known practice. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can be formed such that the film is cooled then wound as a completed material.

It is within the purview of the present invention to utilize a nonwoven fabric within the laminate. The nonwoven fabric may be a carded fabric or continuous filament fabric. Continuous filament fabrics involves the spunbond process, wherein a molten polymer is supplied, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs is collected upon the uppermost surface of the previously formed web. The web is then at least temporarily consolidated, usually by means involving heat and pressure, such as by thermal point bonding. Using this bonding means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the melt blown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll.

The durable protective laminate of the present invention is comprised of a vapor corrosive inhibitor (VCI). The VCI chemistry protects metal goods from the elements of the environment. The precise chemical composition of the vapor phase corrosion inhibitor may vary as there are a number of commercially available products that can be readily used. However, due to carcinogenic concerns that have recently come to the attention of medical researchers, the vapor phase corrosive inhibitor utilized in the present invention is preferably devoid of nitrite compounds. Typically, the vapor corrosive inhibitor compounds that do not contain nitrite compounds and that are commercially available are formulations comprising amine benzoates, amine nitrates or benzotriazole. In accordance with the present invention, the VCI chemistry is incorporated into the film as a melt additive. The VCI additive may also be incorporated into a nonwoven layer as a melt additive or topical treatment.

It has been contemplated that the durable protective laminate comprises two or more layers. Additional layers may be wovens, nonwovens, films, or a combination thereof. Also, subsequent to formation, the laminate may also be exposed to various post treatments.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A method of making a durable protective laminate comprising the steps of:
a. providing a woven fabric;
b. providing a polyolefin melt;
c. providing an adhesive;
d. providing a film, wherein said film comprises a vapor corrosive inhibitor;
e. extruding said polyolefin melt onto said woven on a first side;
f. sputter coating the edges of said woven on a second side with said adhesive; and
g. laminating said woven fabric with said film.

2. A method of making a durable protective laminate as in claim 1, wherein said woven is a polyolefin selected from the group consisting of polypropylene, polyethylene, their derivatives, and the combinations thereof.

3. A method of making a durable protective laminate as in claim 1, wherein said polyolefin melt is selected from the group consisting of polypropylene, polyethylene, their derivatives, and the combinations thereof.

4. A method of making a durable protective laminate as in claim 1, wherein said film is a polyolefin selected from the group consisting of polypropylene, polyethylene, their derivatives, and the combinations thereof.

5. A method of making a durable protective laminate as in claim 1, wherein said protective laminate is two or more layers.

6. A method of making a durable protective laminate as in claim 1, wherein said vapor corrosive inhibitor is a melt additive.

7. A method of making a durable protective laminate as in claim 1, wherein said adhesive is 3-4 inches wide along said edges of said woven fabric.

8. A method of making a durable protective laminate comprising the steps of:
a. providing a woven fabric;
b. providing an adhesive;
c. providing a film, wherein said film comprises a vapor corrosive inhibitor;
d. sputter coating the width of said woven fabric with said adhesive; and
e. laminating said woven with said film.

9. A method of making a durable protective laminate comprising the steps of:
a. providing a woven fabric;
b. providing a nonwoven fabric, wherein said nonwoven comprises a vapor corrosive inhibitor;
c. sputter coating the edges of said woven fabric with an adhesive; and
d. laminating said woven with said nonwoven.

10. A method of making a durable protective laminate as in claim 9, wherein said nonwoven fabric is a filamentary fabric.

11. A method of making a durable protective laminate as in claim 9, wherein said vapor corrosive inhibitor is a melt additive.

12. A method of making a durable protective laminate as in claim 9, wherein said nonwoven fabric is a carded staple fiber fabric.

13. A method of making a durable protective laminate as in claim 9, wherein said vapor corrosive inhibitor is topically applied.
